(19) United States
(12) Patent Application Publication
(10) Pub. No.: US 2001/0015201 A1
(43) Pub. Date: Aug. 23, 2001

(54) Gas grill with tank holding strut and scale

(75) Inventors: Curtis H. Pollock III, Buena Vista, GA (US); Aron P. Lewis, Lanett, AL (US); Alex T. Gafford, Midland, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: W.C. Bradley Company, Columbus, GA (US)

(21) Appl. No.: 09/773,836

(22) Filed: Jan. 31, 2001

Related U.S. Application Data
(63) Continuation-in-part of application No. 09/353,758, filed on Jul. 14, 1999, now Pat. No. 6,135,104.
Application No. 09/353,758 is a continuation-in-part of application No. 09/134,211, filed on Aug. 14, 1998, now Pat. No. 5,931,149.
(60) Provisional application No. 60/179,165, filed on Jan. 31, 2000.

(51) Int. Cl. A47J 37/00

(52) U.S. Cl. 126/41 R

(57) ABSTRACT

A barbecue grill comprising a grill cart assembly, an LP gas tank having a base and being removably mounted to the grill cart assembly, a grill assembly mounted to the grill cart assembly, and a tank strut comprising a strain-measuring device, which tank strut can be stationary or rotatable. The strain measuring device indicates the weight of the tank and the LP gas therein to give an indication of the amount of LP gas in the tank.

### CROSS-REFERENCE TO RELATED APPLICATIONS

This application is a Continuation-In-Part application which is based on and claims priority to Provisional Application Serial No.: 60/179,165 filed Jan. 31, 2000, Continuation-In-Part application Ser. No. 09/353,758, filed Jul. 14, 1999 which is based on and claims priority to U.S. patent application Ser. No. 09/134,211, filed Aug. 14, 1998, now U.S. Pat. No. 5,931,149, issued on Aug. 3, 1999.

### BACKGROUND OF THE INVENTION

1. Field of the Invention

The present invention relates generally to barbecue grills and, more particularly, to a gas grill which incorporates a strut that includes a tank scale for weighing a gas supply tank.

2. Description of the Related Art

Gas fired barbecue grills are commonly mounted on wheeled carts and are fueled by LP gas, such as liquid propane gas, from a tank mounted on the cart. Typically, an LP gas tank is mounted on a supporting strut or on a lower shelf of the cart, usually at one end or the other of the cart, thereby providing easy access for removing and replacing the tank. When a tank has been emptied, it is disconnected from a gas regulator hose assembly and removed from its mounted position upon the cart and then typically transported to a refilling station. After the tank has been refilled, it is then remounted beneath the grill and reconnected to the gas regulator hose assembly. The grill may then be utilized for barbecuing once again.

An LP gas tank typically weighs approximately forty pounds when filled and typically can supply a grill with enough gas for intermittent cooking for a period of months. When subjected to near continuous use, however, such a tank may only be able to supply a grill with enough gas for cooking for a few days. Therefore, it is useful to have an accurate measurement of the amount of gas within a tank at all times. Heretofore, however, some prior art devices for measuring the amount of gas in a tank have not met what might be termed a high reliability standard or have tended to be easily damaged, thereby decreasing their reliability. Uncertainty regarding the amount of gas remaining in an LP gas tank is particularly unacceptable when the meal being prepared is only half-cooked when the tank runs dry.

Therefore, there exists a need for improved grills and particularly a gas measuring capability which address these and other shortcomings of the prior art.

### SUMMARY OF THE INVENTION

The present invention is an improved barbecue grill. The barbecue grill comprises a grill cart assembly, an LP gas tank having a base removably mounted to the grill cart assembly, a grill assembly mounted to the grill cart assembly, and a tank strut comprising a strain-measuring device. The grill cart assembly has a first leg assembly which has a front leg and a rear leg where the tank support strut is mounted therebetween. The tank support strut has a first longitudinal axis and is capable of rotation about the first longitudinal axis between a receiving position and a mounted position. The tank support strut is mounted such that an LP gas tank is arranged in a substantially upright orientation.

A further embodiment of the present invention is a tank strut that is made of a base, tank-receiving member and a fuel gauge. The strain-measuring device is located between the base and the tank-receiving member and is electrically connected to the fuel gauge. The tank-receiving member comprises a top side and a bottom side. The top side of the tank-receiving member comprises recesses for the lower rim of an LP gas tank. The bottom side of the tank-receiving member comprises at least one load transferring member. The fuel gauge produces a signal to signify the amount of fuel remaining in the tank using one or more light emitting diodes or another suitable indicator, for example, a gauge or dial indicator.

Another embodiment of the present invention is a barbecue grill comprising a grill cart assembly, an LP gas tank having a base removably mounted to the grill cart assembly, a grill assembly mounted to the grill cart assembly, and a tank strut comprising a strain-measuring device. The tank strut is made of a base, tank-receiving member and a fuel gauge. The strain-measuring device is located between the base and the tank-receiving member and is electrically connected to the fuel gauge. The tank-receiving member comprises a top side and a bottom side. The top side of tank-receiving member comprises recesses for the lower rim of an LP gas tank. The bottom side of the tank-receiving member comprises at least one load transferring member. The fuel gauge produces a signal to signify the amount of fuel remaining in the tank using one or more light emitting diodes.

Other features and advantages of the present invention will become apparent to one with skill in the art upon examination of the following drawings and detailed descriptions. It is intended that such additional features and advantages be included herein within the scope of the present invention.

### BRIEF DESCRIPTION OF THE SEVERAL VIEWS OF THE DRAWINGS

The present invention, as defined in the claims, can be better understood with reference to the following drawings. The drawings are not necessarily to scale, emphasis instead being placed on clearly illustrating the principles of the present invention.

FIG. 1 is a partially cut-away, perspective view of a preferred embodiment of the present invention incorporated into a representative barbecue grill.

FIG. 2A is a partially-exploded, perspective view of a preferred embodiment of a strut.

FIG. 2B is a perspective, bottom view of the upper member of the strut depicted in FIG. 2A.

FIG. 3 is a partially cut-away, perspective view of a preferred embodiment of a rotating strut incorporated into a barbecue grill.

FIG. 4 is a flow chart depicting the various meanings of the illuminated light emitting diodes on the fuel gauge.

FIG. 5A is a flow chart depicting the low battery feature of this invention.

FIG. 5B is a flow chart depicting the manual off feature of this invention.

FIG. 5C is a flow chart depicting what will happen when a new battery is installed into the invention.

FIG. 6 is a flow chart depicting the automatic operation of the electronic fuel gauge, as related to the weight of fuel present in the tank.

### DETAILED DESCRIPTION OF A PREFERRED EMBODIMENT

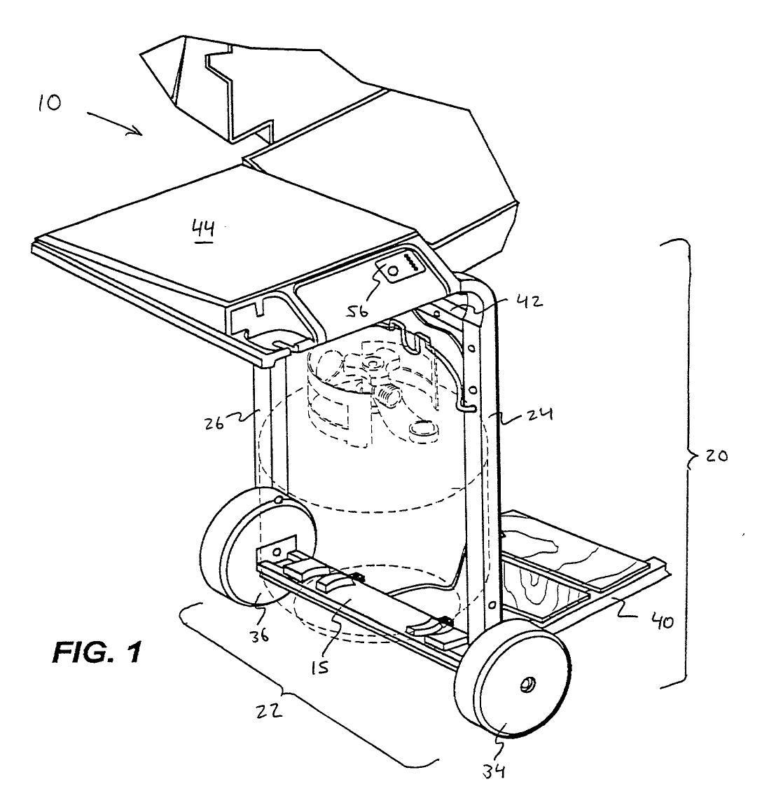

Reference will now be made in detail to the description of the invention as illustrated in the drawings with like numerals indicating like parts throughout the several views. FIG. 1 depicts a barbecue grill 10 incorporating a cart assembly 20 with which the tank strut 15 of the present invention is utilized. In general, the cart assembly 20 incorporates two leg assemblies, one of which is shown. Wheeled leg assembly 22 includes front leg 24 and rear leg 26 connected by tank strut 15. Wheels 34 and 36 are connected to the cart legs, 24 and 26 respectively, to provide mobility to the grill 10, as is well known in the art. Bottom shelf assembly 40 and upper strut 42 also are connected to the cart legs 24, 26 to complete the cart assembly 20, thereby forming a rigid structure which serves to both support and transport grill assembly 44.

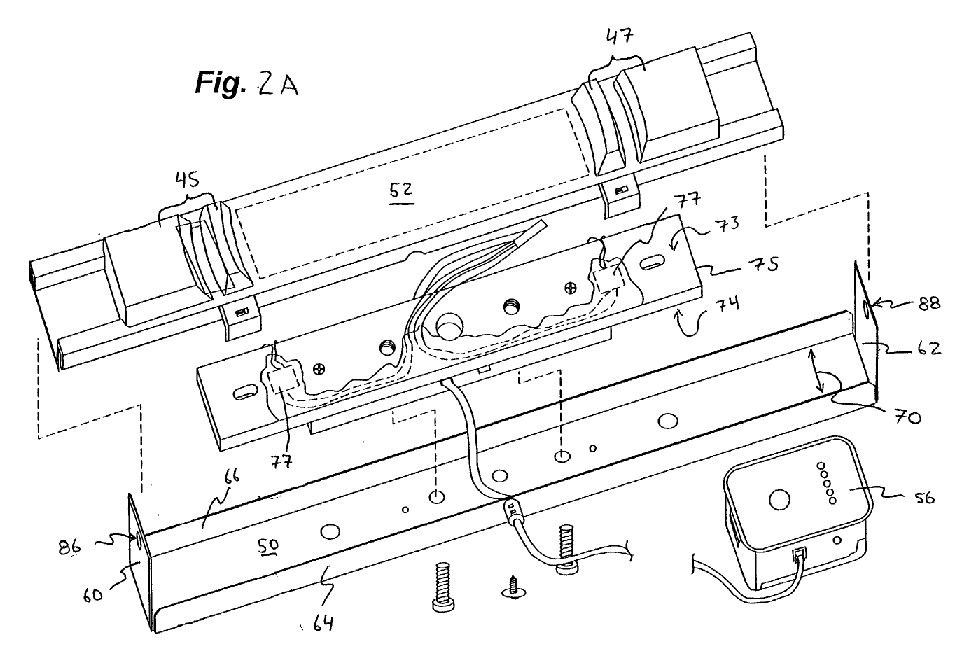

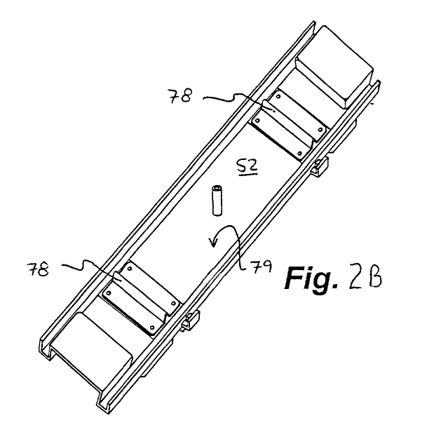

As shown in detail in FIG. 2A, a preferred embodiment of tank strut 15 is configured as an elongated member, formed of steel or other suitable materials, with a base 50, an upper or tank-receiving member 52 and a fuel gauge 56. Opposed end walls 60 and 62 extend upwardly from the base 50, each having a bore 86, 88 disposed thereon, respectively, with a pair of side walls 64 and 66 extending therebetween to define a cavity 70. Preferably, end walls 60 and 62 are sufficiently spaced from each other, so that tank-receiving member 52 may be received therebetween for enclosing the cavity 70.

Within cavity 70, a strain-measuring device 75 is provided. Strain-measuring device 75 includes strain gauges 77, preferably arranged on both the upper 73 and the lower 74 surfaces thereof which are each adapted to generate a signal corresponding to the strain imparted thereupon by a tank 93 (not shown). Preferably, when a tank 93 is positioned with its lower rim 96 seated within the recesses 45, 47 of the tank receiving member 52, the weight of the tank 93 is transferred downwardly to the strain-measuring device 75 via at least one load transferring member 78 (FIG. 2B). Load transferring members 78 extend across the bottom surface 79 of the tank receiving member 52 and engage the strain-measuring device 75. The signals so generated are then delivered to the fuel gauge 56, which then produces a corresponding readout or display which is reflective of the amount of fuel remaining in the tank 93.

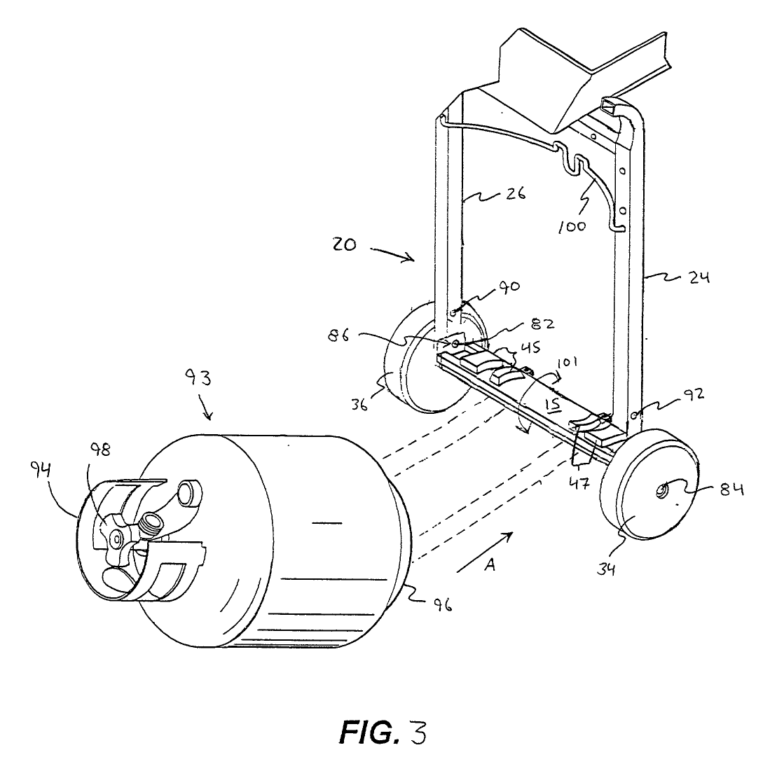

In FIG. 3, the preferred embodiment, strut 15 may be rotatably mounted between legs 24 and 26 by means of axles 82 and 84 which are coaxial and which cooperate with bores 86 and 88 (not shown), and which also rotatably mount wheels 34 and 36. Axles 82 and 84 are maintained in proper position in a conventional manner, such as by inserting a cotter pin (not shown) through a transverse bore (not shown) which is formed through the distal end of each axle, by engaging an externally threaded distal end of each axle with an internally threaded nut, etc., as is known in the art. While the present strut 15 is shown as coaxially mounted with the wheels 34 and 36, it is also contemplated by the present invention that the strut 15 can be mounted at any level between the legs 24, 26 of the cart assembly 20. For example, the strut 15 can utilize bores 90 and 92, as well as appropriate connecting means (not shown), such as bolts, pins, rods, etc., so as to support and be able to rotate for the mounting and removal of the gas tank 93.

LP gas tanks, such as gas tank 93, typically incorporate a tank collar 94 which is normally welded to the upper portion of the gas tank 93, and a base 96 which is normally welded to the lower portion of the tank 93. The tank collar 94 is typically constructed in a circular shape so as to protect an LP gas valve 98 to which a gas regulator hose assembly (not shown) is attached. The gas regulator hose assembly conveys LP gas from the tank 93 to a burner unit (not shown) which is mounted in the grill assembly 44. It is common practice that tank collar 94 also doubles as a carrying handle for transporting the tank 93 to refilling stations, and for return to the barbecue grill cart assembly 20 for reinstallation.

An LP gas tank 93 can be supported by the strut 15 both during and after installation. For instance, when the gas tank 93 has been emptied, it is disconnected from the gas regulator hose assembly (not shown) and any associated securing means, such as tank holding wire 100, or other conventional means. The tank 93 is then removed from its mounted position upon the tank support strut 15 by tilting the tank 93 outwardly toward a horizontal position, facilitated by the rotation 101 of the strut 15. A filled tank 93 is then placed on its side adjacent the support strut 15 which has been rotated 101 to a receiving position. The tank 93 is then moved laterally toward the strut 15 until the lower rim of the base 96 of the tank 93 engages the strut 15. Once so engaged, the support strut 15 and the gas tank 93 can be conveniently and simultaneously rotated upwardly and inwardly toward the cart assembly 20 to the mounted position so that the tank 93 is arranged in a substantially upright orientation upon the strut 15 (FIG. 1). The securing means, i.e. a tank wire 100, is reattached to the tank 93 in order to maintain the tank 93 in a substantially upright position, thereby functioning as a locking mechanism for substantially maintaining the strut 15 and tank 93 in the mounted position. The tank 93 is then reconnected to the gas regulator hose assembly (not shown).

In preferred embodiments, recesses 45 and 47 are oriented in a arrangement for promoting engagement of the recesses 45 and 47 with the base 96 of an LP gas tank; however, the recesses 45 and 47 can be formed in various sizes, shapes and configurations depending on the particular application. For example, the spacing of the notches along the side walls can be varied in a known manner so that the orientation of the gas tank 93 relative to the strut 15 can be adjusted.

Furthermore, it should be noted that the strut 15 is oriented so that an LP gas tank 93 supported on the support strut 15 can be rotated about the longitudinal axis of the strut 15 and then removed from the strut 15 without the gas tank 93 being inhibited by the legs 24, 26 of the cart assembly 20. In addition, the strut 15 can be stationary or in a fixed position and not rotate in the manner described above.

A conventional LP gas tank commonly provided for use with gas barbecue grills weighs approximately 18 pounds when empty. The tank is designed to hold approximately 20 pounds of LP gas. Typically, one pound of LP gas will provide about one half to one full hour of cooking. Numerous variables affect this estimate, such as: the size of the burner, the amount of gas transferred using high, medium, or low valve positions, the use of a portion of the burner vs. using the entire burner, and others. Taking such variables into account, and knowing the approximate weight of the LP gas remaining in the tank as well as the approximate performance specifications of the grill, permits the user to gauge the amount of cooking time available before the tank needs to be refilled or changed over to a substitute, full tank. For example, a gas grill producing 42,000 btu/hr will provide between one half to one full hour of cooking time for one pound of gas dependent on whether the entire burner or half the burner is used, since one pound of LP gas provides approximately 21,000 btu/hr. This knowledge enables the user to utilize the measurements provided by the fuel gauge as described hereinbelow.

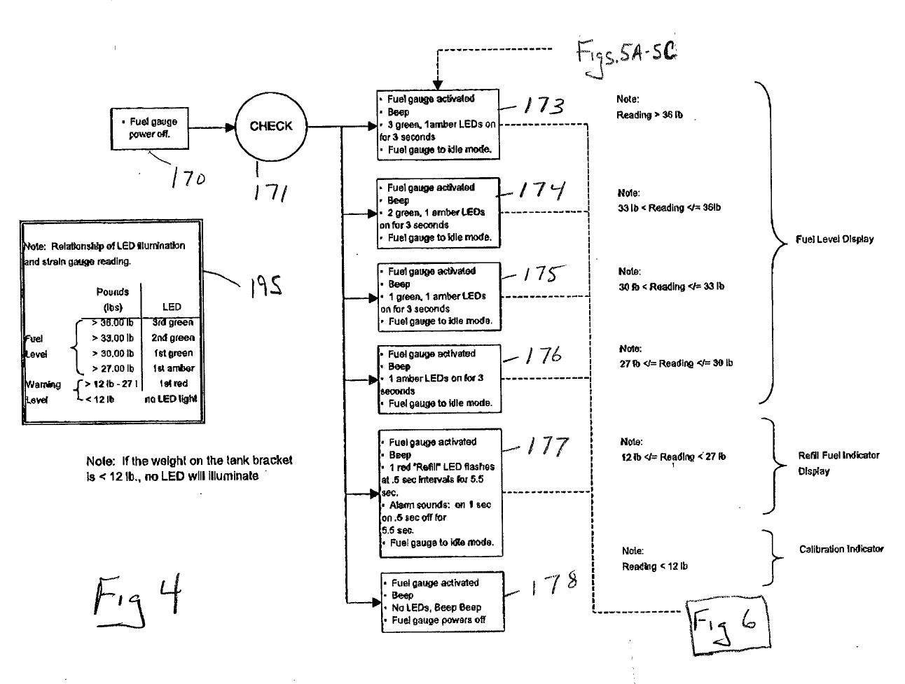

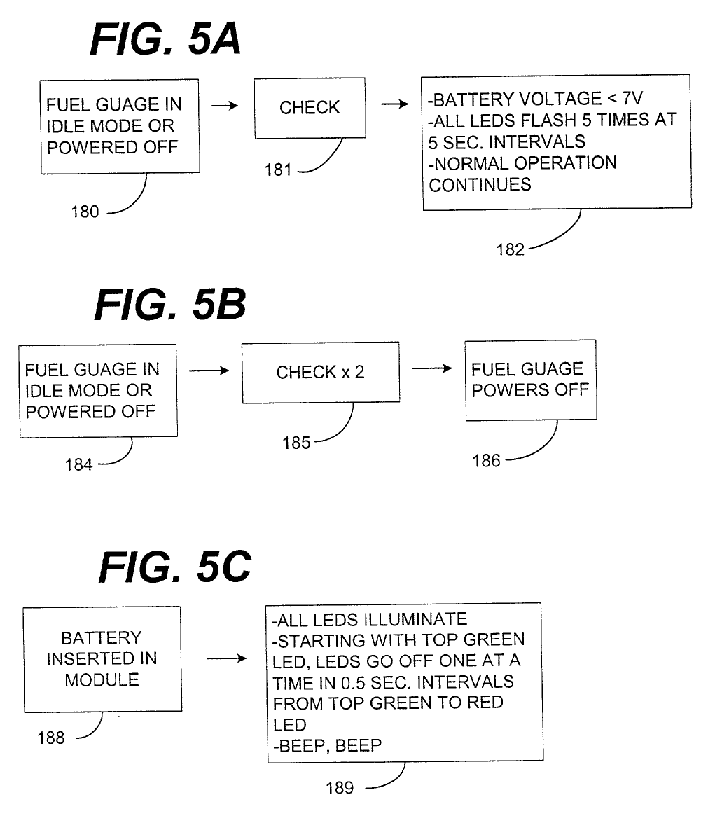

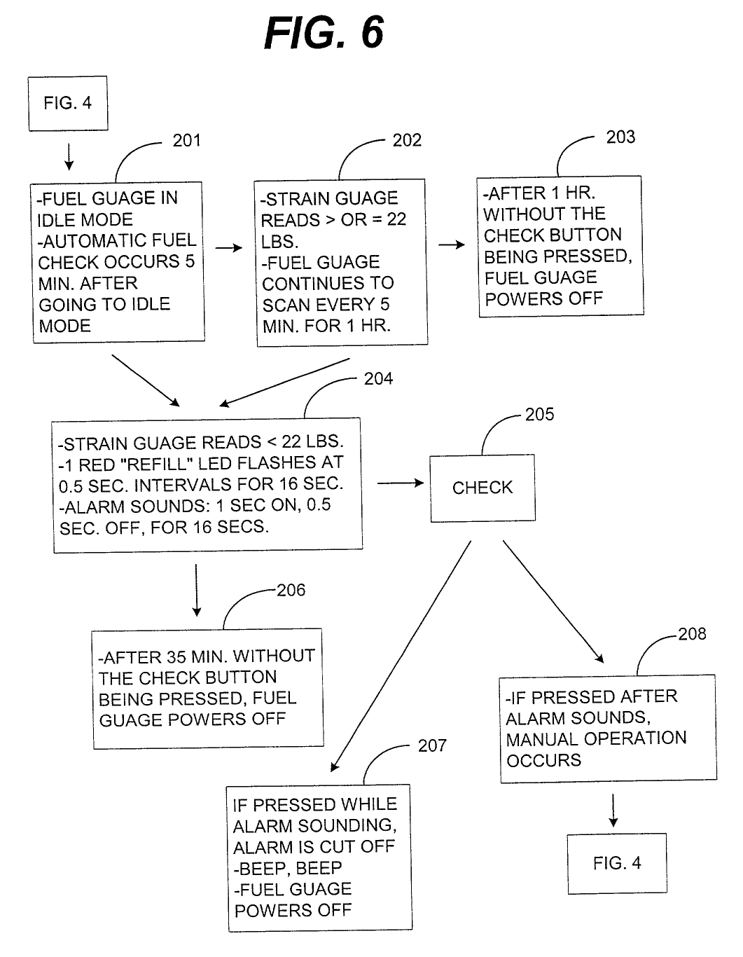

FIGS. 4-6 are representative flow charts depicting the functionality of a preferred embodiment of the fuel gauge 56. FIG. 4 is a representative flow chart that depicts the various meanings of the illuminated light emitting diodes (LEDs) on the fuel gauge. Initially, the fuel gauge is powered off 170, then by depressing the check button 171 the fuel gauge is activated and will beep. Referring to the chart designated 195 in FIG. 4, three green LEDs and one amber LED will illuminate for three seconds if the gas tank weighs more than 36 pounds. If only two green LEDs and one amber LED are illuminated for three seconds, then the gas tank weighs between 33 and 36 pounds 174. If only one green LED and one amber LED are illuminated for three seconds, then the gas tank weighs between 30 and 33 pounds 175. If only one amber LED is illuminated for three seconds, then the gas tank weighs between 27 and 30 pounds 176. Further, the tank weighs between 12 and 27 pounds if one red refill LED flashes at 0.5 second intervals for 5.5 seconds and an alarm sounds for one second on and 0.5 a second off for 5.5 seconds 177. Lastly, if no LEDs illuminate, then the tank weighs less than 12 pounds 178 and is substantially empty. Subtracting the weight of the tank from these readings plus the five additional pounds of the assembly force [(tank, tank wire, regulator, HVR assembly) i.e. 36 lb reading: 36 lbs (reading)−18 lb. (tank)=18 lbs.−5 lbs. (assembly)=13 lbs. fuel (using an 18 lb tank)] gives the user the weight of the gas remaining in the tank. By altering the weight range at which the LEDs and alarm of the fuel gauge 56 function, an embodiment of the present invention may be utilized to indicate the amount of LP gas remaining in various sized LP gas tanks.

FIG. 5A describes the low battery detection feature. If the fuel gauge is in idle mode or powered off 180 and then the check button 181 is depressed, a low battery indication will result if the battery voltage is less than 7 volts. In this case all of the LEDs will flash five times at five second intervals to indicate that the battery voltage is less than 7 volts 182. After the LEDs flash five times at five second intervals, normal operation will thereafter continue.

FIG. 5B describes the manual off feature of the fuel gauge 56. If the fuel gauge is in idle mode or powered off 184 and the check button is depressed two times 185, the fuel gauge automatically powers off 186.

FIG. 5C describes what will happen on the control panel after a battery is inserted into the module. After a battery is inserted into the module 188 all LEDs will illuminate. Then, starting with the top green LED, the LEDs will go off sequentially at 0.5 second intervals from the top green LED to the red LED 189.

FIG. 6 is a flow chart that describes the electronic fuel gauge automatic operation. When the fuel gauge is in idle mode, the fuel level is automatically checked five minutes after going into idle mode 201. However, if the strain gauge reads greater than or equal to 22 pounds, the fuel gauge continues to scan every five minutes for one hour 202. Then after one hour without the check button being depressed, the fuel gauge powers off 203. Furthermore, if the strain gauge reads less than 22 pounds, one red LED will flash at 0.5 second intervals for sixteen seconds 204. In addition, an alarm sounds for one second on and 0.5 a second off for sixteen seconds. If the check button is not depressed within 35 minutes, the fuel gauge powers off 206. Alternatively, if the check button is depressed 205 while the alarm is sounding, the alarm is cut off and the fuel gauge will power off 207. Or, if the check button is pressed after the alarms sounds, manual operation will continue 208.

FIGS. 4 through 6 have been presented for purposes of illustration and description. They are not intended to be exhaustive or to limit the invention to the precise forms disclosed. For example, in FIGS. 4 and 6, the correlation between the number of illuminated LEDs to the fuel weight can vary in numerous ways as would be obvious to one skilled in the art. Also in FIGS. 5A, 5B, 5C, and FIG. 6, the duration that the fuel gauge continues to scan can vary, as well as the intervals between the flashing LEDs and the length of the time that the LEDs will flash. Many modifications and variations can be applied and used and the foregoing is merely an example of a preferred embodiment of the invention.

The foregoing description has been presented for purposes of illustration and description. It is not intended to be exhaustive or to limit the invention to the precise forms disclosed. Obvious modifications or variations are possible in light of the above teachings. The embodiment or embodiments discussed, however, were chosen and described to provide the best illustration of the principles of the invention and its practical application to thereby enable one of ordinary skill in the art to utilize the invention in various embodiments and with various modifications as are suited to the particular use contemplated. All such modifications and variations, are within the scope of the invention as determined by the appended claims when interpreted in accordance with the breadth to which they are fairly and legally entitled.

1. An improved barbecue grill comprising:
a grill cart assembly;
an LP gas tank having a base removably mounted to said grill cart assembly;
a grill assembly mounted to said grill cart assembly;
a tank strut comprising a strain-measuring device; and
said grill cart assembly having a first leg assembly, said first leg assembly having a front leg, a rear leg and said tank support strut mounted therebetween, said tank support strut having a first longitudinal axis and being capable of rotation about said first longitudinal axis between a receiving position and a mounted position, said tank support strut in said mounted position engaging said base of said LP gas tank such that said LP gas tank is arranged in a substantially upright orientation between said tank support strut and said grill assembly.

2. The improved barbecue grill of claim 1, wherein said tank strut comprises a base, tank-receiving member, and a fuel gauge.

3. The improved barbecue grill of claim 2, wherein said strain-measuring device is located between said base and said tank-receiving member and is electrically connected to said fuel gauge.

4. The improved barbecue grill of claim 3, wherein said tank-receiving member comprises a top side and a bottom side.

5. The improved barbecue grill of claim 4, wherein said top side of tank-receiving member comprises recesses for the lower rim of the LP gas tank.

6. The improved barbecue grill of claim 4, wherein said bottom side of tank-receiving member comprises at least one load transferring member.

7. The improved barbecue grill of claim 3, wherein said fuel gauge produces a signal to signify the amount of fuel remaining in a tank using one or more light emitting diodes.

8. An improved barbecue grill comprising:
a grill cart assembly;
an LP gas tank having a base removably mounted to said grill cart assembly;
a grill assembly mounted to said grill cart assembly; and
a tank strut comprising a strain-measuring device.

9. The improved barbecue grill of claim 8, wherein said tank strut comprises a base, a tank-receiving member, and a fuel gauge.

10. The improved barbecue grill of claim 9, wherein said strain-measuring device is located between said base and said tank-receiving member and is electrically connected to said fuel gauge.

11. The improved barbecue grill of claim 10, wherein said tank-receiving member comprises a top side and a bottom side.

12. The improved barbecue grill of claim 11, wherein said top side of tank-receiving member comprises recesses for the lower rim of the LP gas tank.

13. The improved barbecue grill of claim 11, wherein said bottom side of tank-receiving member comprises at least one load transferring member.

14. The improved barbecue grill of claim 10, wherein said fuel gauge produces a signal to signify the amount of fuel remaining in a tank using one or more light emitting diodes.

15. A fuel tank support strut wherein said fuel tank support strut is capable of determining the amount of fuel present in a tank having a lower rim, comprising:
a base member said base member having a first end and a second end, said first end and said second end configured to suspendedly support said base member;
a tank receiving member, said tank receiving member having a top side and a bottom side, said top side having a recess configured to receive the lower rim of the tank, said bottom side of said tank receiving member having at least one load transferring member;
a strain measuring device, said strain measuring device having a first side and a second side, said strain measuring device having a strain gauge disposed thereon;
a fuel gauge, said fuel gauge being electrically connected to said strain measuring device and configured to indicate the fuel remaining in the tank;
wherein said strain measuring device is located between said base member and said tank receiving member and is electrically connected to said fuel gauge.

16. The fuel tank support strut of claim 15, said fuel tank support strut being configured to rotate about a longitudinal axis passing between said first and said second ends of said base member.

17. The fuel tank support strut of claim 16, said fuel gauge producing a signal to signify the amount of fuel remaining in the tank using one or more light emitting diodes.

18. The fuel tank support strut of claim 15, said strain measuring device having said strain gauge disposed on said first and or said second side.

19. The fuel tank support strut of claim 16 having a barbecue grill, said fuel tank support strut being supported at said first end and said second end of said base member by a first leg and a second leg of the barbecue grill, respectively.

20. The fuel tank support strut of claim 18, having a first axle and a second axle, said first axle and said second axle rotatably connecting said first end and said second end of said base member to the first leg and the second leg of the barbecue grill, respectively.
